(19) United States
(12) Patent Application Publication
(10) Pub. No.: US 2005/0188107 A1
(43) Pub. Date: Aug. 25, 2005

(54) Redundant pipelined file transfer

(76) Inventors: Benjamin F. Piercey, Richmond (CA); Marc A. Vachon, Ottawa (CA); Henry Albert Bailey, Kemptville (CA); William Gerald Love, Ottawa (CA); Ian Van Gough, Ottawa (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 11/034,852

(22) Filed: Jan. 14, 2005

Related U.S. Application Data
(60) Provisional application No. 60/536,227, filed on Jan. 14, 2004.

(51) Int. Cl. G06F 15/173

(52) U.S. Cl. 709/238

(57) ABSTRACT

A mechanism for point-to-multipoint file transfer utilizes a pipeline architecture established through a set of networking messages to transfer a file from a source node to a plurality of recipient nodes. Each node in the pipeline can utilize a redundant connection to a next nearest neighbor in the pipeline to decrease the time required to recover from a node failure.

### CROSS REFERENECE TO RELATED APPLICATIONS

This application claims the benefit of U.S. Provisional Application No. 60/536227, which is incorporated herein by reference.

### FIELD OF THE INVENTION

The present invention relates generally to file transfer mechanisms in data networks. More particularly, the present invention relates to a pipelined file transfer mechanism for transferring data from a single source to multiple recipients.

### BACKGROUND OF THE INVENTION

In packet-based networks, transfer of files is commonly accomplished as a network node-to-network node operation. For many purposes, this point-to-point file transfer paradigm is sufficient. However, if a single node is required to transmit data to multiple recipient nodes, point-to-point mechanisms cannot be used without adverse effects, such as inefficiencies in the file transfer or network congestion.

To avoid the overhead of having the source node transmit an entire file set to each recipient node, there exists a multitude of multicast file transfer mechanisms. These mechanisms allow a single source node to transfer data to a subset of the nodes in the network, which differentiates multicasting from broadcasting

In the typical hub and spoke set up of data networks, where a plurality of nodes radiate from a switch, router or networking hub, multicast data transmission typically relies upon the availability of Internet Group Multicast Protocol (IGMP) snooping functionality at the switch. Alternately a central router can employ the Cisco™ Group Multicast Protocol. IGMP allows for an OSI layer-2 device to determine that a data packet is associated with a multicast data transfer and route the packet to multiple destinations. However, many switches do not support IGMP. In this case, the switch is blind to the multicast nature of the data packets and the multicast packets are transmitted over all switch or router interfaces, turning the multicast into a broadcast.

While in the confines of a carefully managed network, with near infinite resources, this situation can be accommodated; real-world networks are typically incapable of handling large broadcasts of data without congestion problems. Network congestion results in packet collision and lost data packets. Thus, in addition to consuming a disproportionate amount of the available bandwidth, a multicast attempt through a non-IGMP compliant switch often results in destination nodes failing to receive packets. Unless a carefully designed acknowledgement system is derived, the source node may have to transmit redundant data packets to all nodes, through an unintended broadcast, which may result in packets in the re-broadcast being lost. One skilled in the art will appreciate that such a system results in network congestion that is unacceptable in data networks.

Many software applications require the combined resources of a number of computers connected together through standard and well-known networking techniques (such as TCP/IP networking software running on the computers and on the hubs, routers, and gateways that interconnect the computers). In particular, Grid or Cluster-based high performance computing solutions make use of a network of interconnected computers to provide additional computing resources necessary to solve complex problems.

These applications often make use of large data files that must be transmitted to each node in the grid or cluster. It would be desirable to provide a system and method that would increase overall bulk file transfer rates and provide both reliability and generates traffic directed to only the network nodes of interest. Unfortunately, standard data transfer techniques are not capable of transferring these files from one machine to many machines in a cluster or grid in a short period of time without sending data to network nodes not part of the file transfer.

Web technologies such as hypertext transfer protocol (http) servers/clients and the http protocol will establish many individual connections from the web server to the destination machines. However, this relies upon the destination machine initiating the file transfer. Additionally, though this approach is reliable, the http server is a bottleneck. The capacity of the connection between the http server, or source node, and the rest of the network is split between each destination node that initiates a connection and file transfer. Thus, such a solution is not considered to be scalable past the capacity of the available connection. In a network where any node can be the source node, no one node can have its connection optimized to avoid this problem. Employing custom scaling approaches such as http redirection does help, but the approach is resource intensive.

Many peer-to-peer technologies attempt to decrease file transfer times by transferring files from multiple sources to a singe destination. These techniques are not applicable as they are many-to-one file transfer mechanisms, not one-to-many file transfer mechanisms.

It is, therefore, desirable to provide a one-to-many file transfer mechanism that does not result in saturation of the network bandwidth.

### SUMMARY OF THE INVENTION

It is an object of the present invention to obviate or mitigate at least one disadvantage of previous many-to-one file transfer mechanisms.

In a first aspect of the present invention, there is provided a method of one-to-many file transfer. The method includes the steps of establishing a pipeline from a source node to a terminal recipient node through a plurality of recipient nodes each having a connection to its nearest downstream neighbor and its next nearest downstream neighbor; transferring a data block from the source node to an index recipient node in the plurality of recipient nodes; at each of the plurality of recipient nodes, forwarding the received data block to the nearest downstream neighbor, and to a storage device; and at the terminal node, forwarding the received data block to a storage device and sending the source node an acknowledgement. In an embodiment of the present invention, the terminal node receives the data block from a nearest upstream neighbor in the plurality of recipient nodes. In another embodiment of the present invention, the step of establishing a pipeline includes transmitting a network setup message containing the pipeline layout to each of the plurality of recipient nodes and to the terminal recipient node, and the nearest downstream neighbour and the next nearest downstream neighbour are determined in accordance with the pipeline layout. The step of transmitting the network setup message to each recipient node includes transmitting the network setup message from the-source node to the index recipient node; at each of the plurality of recipient nodes, receiving the network setup message and forwarding it to the nearest downstream neighbor; and at the terminal recipient node, receiving the network setup message and sending an acknowledgement to the source node. In another embodiment, the step of transferring a data block is preceded by the step of transmitting a file setup message through the pipeline, the file setup message preferably includes at least one attribute of a file to be transferred. Such as a file length and data block size. In another embodiment, the method further includes the steps of detecting, at one of the plurality of recipient nodes, a failure in its nearest downstream neighbor; and routing around the failed node. The step of routing around the failed node can include transmitting data blocks to the next nearest neighbor to remove the failed node from the pipeline, or alternatively it can include designating the next nearest neighbor as the nearest neighbor in the pipeline.

In a second aspect of the present invention, there is provided a node for receiving a pipelined file transfer, the node being part of a pipeline. The node comprises an ingress edge, an egress edge and a state machine. The ingress edge receives a data block from an upstream node in the pipeline. The egress edge maintains both a data connection to a nearest downstream neighbour in the pipeline and a redundant data connection to a next nearest downstream neighbour in the pipeline. The state machine, upon receipt of the data block at the ingress edge, forwards a messaging operator to the egress edge for transmission to the nearest downstream neighbour in the pipeline and forwards the received data block to a storage device. In an embodiment of the second aspect of the present invention, the node includes an ingress messaging interface for receiving messaging operators from upstream nodes, wherein the messaging interface includes means to receive a network setup operator containing a layout of the pipeline, and means to receive a file setup operator containing properties of the file being transferred. In another embodiment of the second aspect, the messaging operator is the received data block. In a further embodiment, the node is the terminal node in the pipeline and the messaging operator is a data complete operator sent to the source of the pipelined file transfer. In another embodiment, the node further includes a connection monitor for monitoring the connection with the nearest neighbour and next nearest neighbour through the egress port and for directing messages to be sent to next nearest neighbor in the pipeline when the nearest neighbor node has failed. The node can also include a messaging interface for receiving data nack operators from one of the nearest neighbour and the next nearest neighbour in the pipeline, and having means to retransmit a stored data block in response to a received data nack operator.

In a third aspect of the present invention, there is provided a method of establishing a one-to-many file transfer pipeline. The method comprises establishing a data connection from a source node to a recipient node and a terminal recipient node; transferring to the recipient node, over the data connection, a network setup message; and establishing a data connection from the recipient node to the terminal node and forwarding, from the recipient node, the received network setup message to the terminal recipient node. In a embodiment of the present invention, the method includes the step of transmitting, from the terminal recipient node to the source node, a messaging operator indicating completion of the pipeline. In a further embodiment, the method includes the step of the recipient node establishing a further one-to-many file transfer pipeline using the terminal recipient node as the recipient node.

In another aspect of the present invention, there is provided a method of one-to-many file transfer. The method comprises establishing a one-to-many file transfer pipeline between a source node, a recipient node and a terminal recipient node, the source node having data connections to both the recipient node and the terminal recipient node, and the recipient node having a data connection to the terminal recipient node; transferring from the source node to the recipient node a data block; forwarding, from the recipient node to the terminal node and to a storage device, the received data block; and at the terminal recipient node, storing the received forwarded data block.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a block diagram illustration of a pipeline of the present invention;

FIG. 2 is a block diagram illustration of a pipeline having a failed node;

FIG. 3 is a block diagram of the architecture of a node of the present invention;

FIG. 4 is a flowchart illustrating a method of the present invention for bypassing a failed node;

FIG. 5 is a flowchart illustrating a method of the present invention for determining if a node has failed;

FIG. 6 is a flowchart illustrating a method of the present invention for establishing a pipelined file transfer;

FIG. 7 is a state diagram of a node of the present invention; and

FIG. 8 is an example of a messaging sequence of the present invention.

### DETAILED DESCRIPTION

Generally, the present invention provides a method and system for pipelined file transfer. A mechanism for point-to-multipoint file transfer utilizes a pipeline architecture established through a set of networking messages to transfer a file from a source node to a plurality of recipient nodes.

Though in the context of the following discussion, the file transfer system and method are described in the context of distributing data to grid computing clusters, this should not be taken as being limiting of the applications of this invention. The file transfer method and system can be used to distribute content in many environments including subscriber lists for managed content such as media files or scheduled operating system upgrades. File sharing systems can also make use of the system of the present invention to allow for content to be disseminated with a reduction in overhead and bandwidth consumption.

The system describe below increases the overall data transfer rate in a defined group while limiting, and distributing, the throughput required by each participant. If proper network mapping is available the order of nodes in the pipeline can be arranged so that the slowest nodes are at the end of the pipeline. Though this will not increase the overall speed of the file transfer, it does allow faster nodes to obtain their data at a faster pace.

In one embodiment of the present invention, a series of TCP based connections in a “pipelined” configuration from the sender to the various receivers is established. In the ideal, each machine establishes one receive stream and multiple send streams, while using the receive stream and only one of the send streams. As data streams into each node, a copy is written to disk while the receive stream is simultaneously, or near simultaneously, replicated to the send stream. The unused connections are preferably established between a machine and its neighbours two or three nodes “downstream”, in order to provide repair of the pipeline in the event of a node failure or communication failure. Thus, a node in the pipeline receives data from an upstream neighbor and forwards it to its nearest downstream neighbor. If the nearest downstream neighbor has experienced a failure, the node redirects traffic to its next nearest downstream neighbor. If not all nodes have the same speed connection, a node that receives data faster than it is able to send data can buffer the data, or simply transmit data based on the record written to disk. One skilled in the art will appreciate that the system of the present invention does not rely upon the use of TCP. Any transport layer, including such protocols as the user datagram protocol (UDP) or reliable UDP can be used. In a presently preferred embodiment, the transport layer provides a data delivery guarantee so that the application layer does not need to perform a completion check.

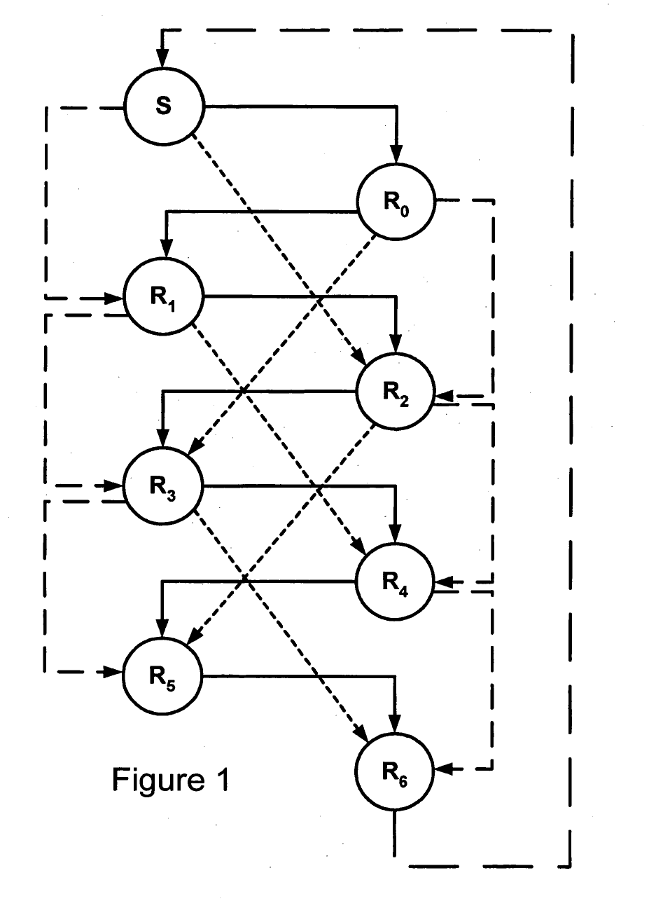

FIG. 1 illustrates an exemplary embodiment of a pipeline in the present invention. Node S is the data source, while nodes R₀ through R₆ are the recipient nodes. Node R₀, being the first recipient node, is referred to as the index recipient node, while node R₆, being the last node in the pipeline, is referred to as the terminal recipient node. A node earlier in the pipeline than another node is referred to as having a lower order, or as a lower order node, while conversely a later node in the pipeline is referred to as a higher order node. The source node is the lowest ordered node, while the terminal recipient node is the highest ordered node. The pipeline file transfer serially links a plurality of recipient nodes together in a chain (as illustrated in FIG. 1 by the solid lines connection S to R₀, R₀ to R₁, R₁ to R₂, R₂ to R₃, R₃ to R₄, R₄ to R₅ and R₅ to R₆. The file for transfer is sent, preferably in packets, from S to R₀. At node R₀ the file is received, sent to the next node in the pipeline and written to disk. One skilled in the art will appreciate that writing the file to disk can precede transfer to the next node, though extra overhead time may be added by virtue of this ordering. As a recipient node receives each packet, it transfers the packet to the next node and writes the packet to disk. This process continues, packet by packet, until the transfer is complete.

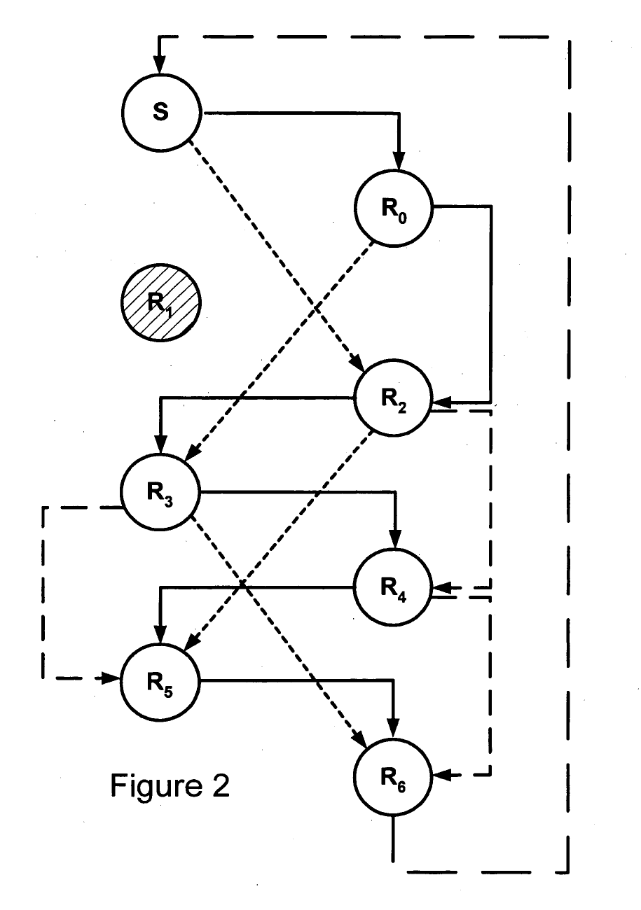

In an embodiment of the present invention, a degree of redundancy is added to accommodate the potential for transmission failure. If, between two nodes, an intermittent problem results in a packet being lost, the recipient node can simply request retransmission of the packet (either explicitly or by failing to transmit an acknowledgement). However, if a node is lost due to failure, the pipeline topology is altered, as illustrated in FIG. 2. This can be dealt with using known techniques for restarting the transmission of a file at a particular offset. However this requires the pipeline to be reformed around the failed node and each node following the failed node is at a different offset, so time must be allowed for the packets to propagate through the pipeline to determine the point at which the file transfer must resume. In an alternate, and presently preferred, embodiment, redundant connections between nodes are employed to maintain efficiency.

FIG. 1 illustrates two sets of redundant connections, the first set in a dashed line, and the second set in a dotted line. One skilled in the art will appreciate that the pipeline can function without the redundant connections, though it is presently preferred that the redundancy is provided to allow for reliability. In the pipeline there are N connections between nodes. If node i, fails, then node i−1 determines that node i has failed, and switches its connection to node i+1. Thus, when a node fails, the preceding node routes around the failure. To allow for multiple nodes failing in series, which may be the result of a physical problem on network segment, the node prior to the failure can attempt to establish connections to each subsequent node, preferably in order, until it finds a live node. Then the failed nodes are left out of the transfer, and the transfer connection pipeline is kept alive.

In FIG. 2, node R₁ has lost its network connection. As node R₀ attempts to transmit data to node R₁, it becomes apparent that the connection has been severed. Because node R₀ knows the network topology and has a fall back connection to node R₂, it can begin transmitting the data that it would have sent to R₁ to R₂.

When node R₀ has received packet x, node R₁ has received packet x-1 and R₂ has received packet x-2 (assuming that all nodes have the same network connection speeds). If R₁ drops out of the network, R₀ will detect the termination of its connection to R₁ and immediately attempt to send packet x to R₂. If R₂ has not yet received packet x-1, it can provide a nack message to R₀ to indicate that it is missing a packet and requires a retransmission of packet x-1 prior to receiving packet x. Alternatively, if out of order packet delivery is permitted, R₂ can receive packet x and then notify R₀. This allows for a resynchronization of the transmitted file.

A widely dashed line connecting R₆ to S is used to allow the source node to be notified that the file has been successfully transferred through the pipeline, as well as to allow other looped back messages.

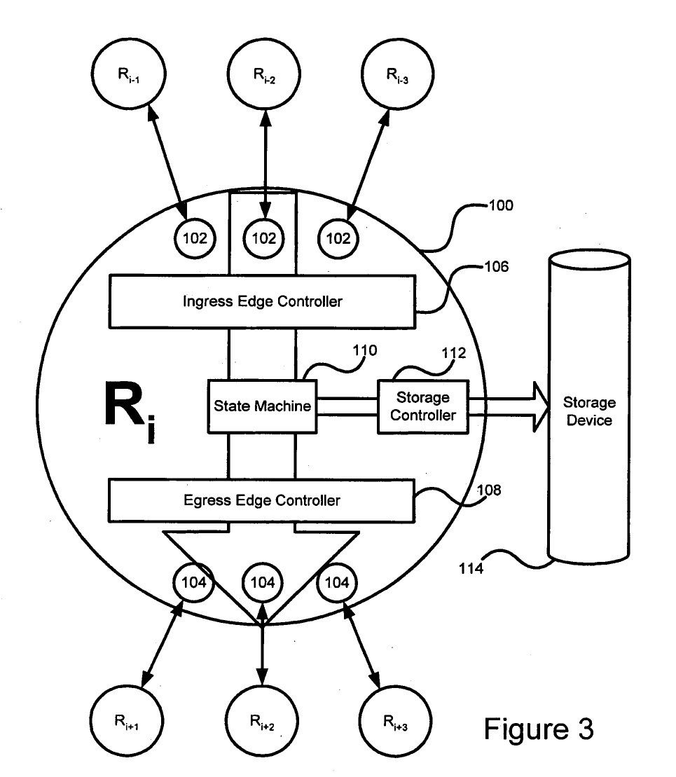

FIG. 3 illustrates an exemplary architecture of a node Rᵢ of the present invention. Each node 100 has a set of ingress and egress edges, represented by the circles 102 and 104 respectively. The ingress and egress edges connect node 100 to external nodes. The ingress and egress edge controllers 106 and 108 control the ingress and egress edges 102 and 104 respectively. Each node 100 preferably has a behaviour that defines how packets are routed from the ingress to egress paths, this behaviour is predetermined, and is preferably controlled by state machine 110. Upon receiving a packet from a preceding node over ingress edge 102, node 100 forwards the received packet to a subsequent node over egress edge 104 and provides the data to the storage controller 112 for storage in the storage device 114. If a subsequent node fails to respond, the packet can be forwarded to the next subsequent node over egress node 104. Though illustrated as having three active ingress connections and three active egress connections, the system of the present invention need not maintain three such active connections. Active connections for the sake of redundancy are not strictly necessary, though maintaining at least one active connection reduces the setup time involved with dropping a node from the pipeline. Any number of connections can be maintained as active without departing from the scope of the present invention. Maintaining more connections as active decreases the setup time for dropping nodes, but increases the overhead associated with the pipeline. The number of active connections can be optimized based on the reliability of the connection between nodes, and the present invention does not require that all nodes maintain an equal number of active connections.

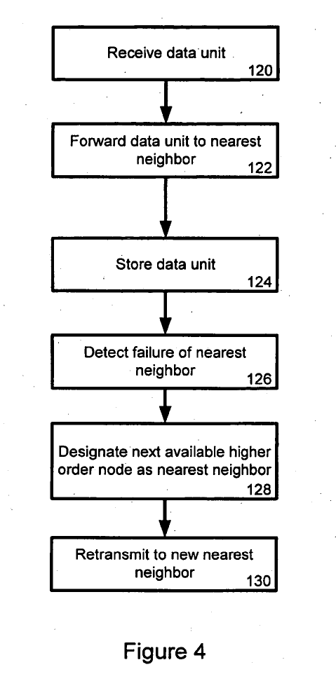

FIG. 4 illustrates a method of the present invention to allow nodes to bypass failed nodes. In step 120, a node receives a data unit. This data unit is part of a file transfer that has been initiated by a source, which has already provided both pipeline setup and file setup information. The received data unit is forwarded to the nearest neighboring node in step 122. The nearest neighboring node is-defined as the next node in the succession of the pipeline defined when the source sets up the pipeline. All nodes following in the pipeline are considered to be higher order nodes, and the nearest neighbor is the active node that is next in the succession. In step 124, the node stores the received data unit. If the forwarding to the nearest neighbor fails, the failure is detected in step 126. This failed node is then dropped from the pipeline and the next available higher order node is designated as nearest neighbor in step 128. The next available higher order node is not necessarily the node that follows the original nearest neighbor, as that node may have also dropped out of the pipeline, especially if both nodes were on the same network segment, and the segment itself has dropped. In step 130, the node retransmits the data unit to the nearest neighbor. One skilled in the art will appreciate that the order of steps 122 and 124 can be reversed, or they can be performed simultaneously without departing from the scope of the present invention.

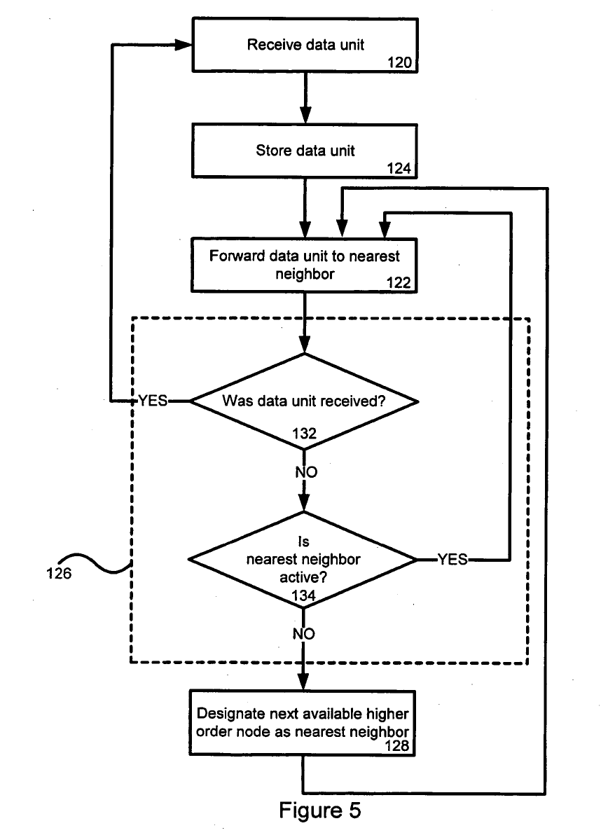

FIG. 5 illustrates a more detailed method that also shows the non-failure case. Steps 120, 122 and 124 proceed as described above, with the exception that steps 122 and 124 have been reversed to illustrate the interchangeability of these steps. If, in step 132, it is determined that the data unit forwarded in step 122 was received, the method loops back to step 120 and continues. However, if the data unit was not received, the node determines if the nearest neighbor is still active in step 134. If the neighbor is still active, the data unit is retransmitted, and the process continues. If the neighbor is determined to be not active, either by sending the data unit a predetermined number of times unsuccessfully, or through other means such as monitoring the connection status, the method proceeds to step 128. In step 128, the next available higher order node is designated at the nearest neighbor, and the method loops back to step 122 to forward the data packet again.

To determine the next available higher order node, active connections can be examined to determine if one of the sessions to an active node is still available, or a new connection can be formed. If no active connections are maintained, the node can examine the pipeline setup information provided by the source during the pipeline establishing procedure and iterate through the next nearest neighbors until one is found that is active.

As described above, if a nearest neighbor node is dropped from the pipeline, the node may be required to retransmit previously transmitted data units to allow the new nearest neighboring node to catch up. In this case the node will either buffer the data units that are being received using node components such as the egress edge controller 108 or the storage controller 112.

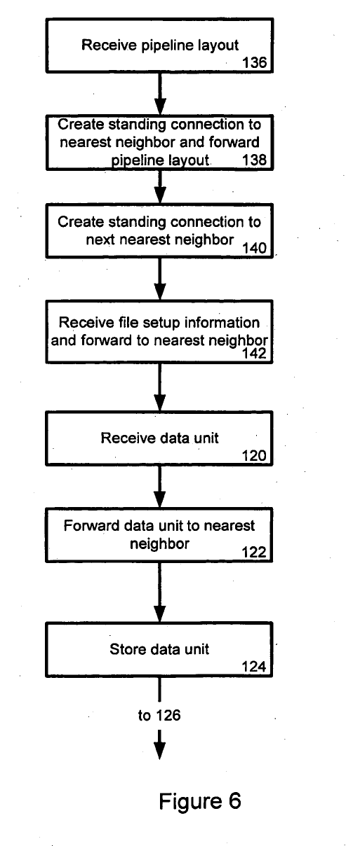

FIG. 6 illustrates steps used during the establishment of the pipeline. When a source sets up a pipeline it transmits both network setup and file setup information. A node in the pipeline receives the network setup, either from the source or from a lower order node. This network setup information includes the pipeline layout information received in step 136. In step 138, as part of the network setup procedure, a standing connection is created to the nearest neighbor as defined by the pipeline layout. When the standing connection is created the pipeline layout information is passed along. In a presently preferred embodiment, a connection to at least one next nearest neighbor is also created to provide redundancy to the pipeline, as shown in step 140. In step 142 the file setup information is received, and is forwarded to the nearest neighbor to allow it to propagate through the pipeline. The file setup information preferably includes the name of the file being transferred, the last modified date, the number of blocks in the file, the size of a block in the transfer, and the size of the last block and the destination path. Other information can be included in various implementations including public signature keys if the data blocks have been signed by the source and checksum information if error correction or detection has been applied. After the file setup has been received and forwarded in step 142, the method continues to step 120 and beyond as described above with reference to FIG. 4. One skilled in the art will appreciate that from the information provided in the file setup message a node may determine that it does not need to receive the data, as it has a copy cached, or otherwise available. In this scenario, the node already having the file can simply forward the data blocks along without storing the file.

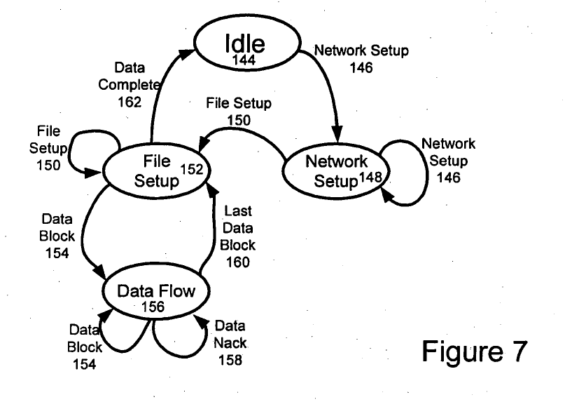

FIG. 7 illustrates the behaviour of state machine 110 in a presently preferred embodiment. As a default, the node is in an Idle state 144. Upon receipt of a network setup operator 146 from either a lower order node or from the source, the node enters a network setup state 148. In the network setup operator, the node preferably receives the topology or layout of the pipeline, instructions regarding how many redundant connections, if any, are required, and other network specific information. The network setup state 148 is maintained until a file transfer is ready. When the source has received confirmation from the last node in the pipeline that the network setup has fully propagated, the source sends a file setup operator 150 through the pipeline. This file setup operator 150 preferably includes the data unit size, the file size (either in absolute terms or as a number of data units), and other information as described above. The file setup operator 150 places the node into a file setup state 152 while it prepares for the file transfer. The file setup state 152 is maintained until the node begins receiving data block 154. The receipt of the first data block 154 in the file puts the node into the data flow state 156. In this state the node receives data blocks 154 and stores them. If the incorrect data block is received a data nack 158 is transmitted and the node awaits an appropriate response. The data nack 158 informs the lower order node that data units have been received out of order and informs the lower order node of the last block successfully received. This allows the node to not worry about receiving acknowledgements for sent packets so long as the connection to the nearest neighbor is maintained, as the node will be informed by receipt of a nack 158 if a packet was not received. Upon receipt of the last data block 160, the node returns to the file setup state 152. If the data transmission is complete, the data complete operator 162 returns the state machine to the idle state 144.

Though not shown, an error operator indicating that the next node is unavailable returns the node from the data flow state 156 to the network setup state 148 to determine which node data should be sent to. Upon completion of the network setup to route around the unavailable, or failed node, the node is returned to the data flow state. This is the most likely predecessor to the receipt of nack messages 158, as it is likely that the new nearest neighbor has not received all the data blocks 154.

The operators for the various states can be thought of as corresponding to messages transmitted through a messaging interface. The network setup operator 146 defines the nodes involved in the transfer, and designates the source node, as well as the redundancy levels if applicable. The file setup operator 150 defines the next file that will be sent through the pipeline. This operator tells each node the size of the file and the number of data blocks in the upcoming transmission as well as other data. In a presently preferred embodiment, this message is looped back to the source by the terminal node so that a decision can be made as to whether or not the file should be sent based on the number of nodes available in the pipeline. The data block 154 is a portion of the file to be transferred that is to be written to disk. The data nack 158 is used when a node failure is detected. Preferably the data nack message includes identification of the block expected by the next node in the pipeline. The data complete operator 162 is used to indicate to all the machines in the pipeline that the transfer is complete. This message allows recipient nodes to reset. In a presently preferred embodiment, the terminal node loops this operator back to the source node, as an acknowledgement operator, so that the source can confirm that all receivers have completed the transfer. One operator not illustrated in the state machine is related to the abort message. The abort message indicates to all nodes in the pipeline that the transfer has been aborted, and allows all recipient nodes to reset. From any state, the abort message allows nodes to return to the idle state.

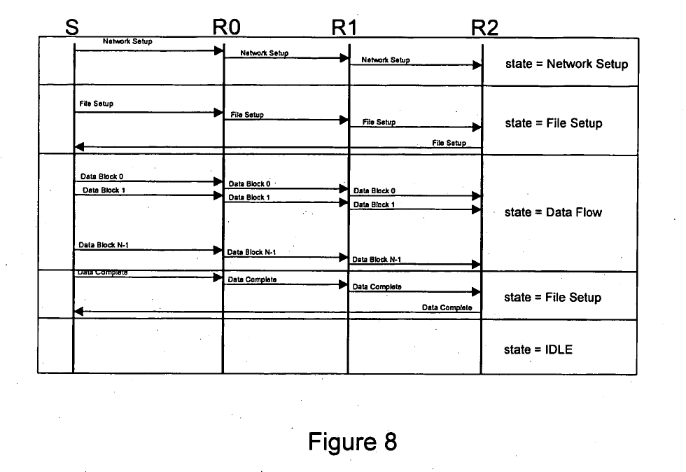

FIG. 8 illustrates an exemplary messaging sequence. In the pipeline for this example there is a source node S, and recipient nodes R₀, R₁ and R₂. Source S initiates the transfer by transmitting a network setup message to node R₀, which pipelines the message to R₂ through R₁. When all nodes have received the message the pipeline is in the Network Setup state. The file setup message is transferred through the pipeline from node S to R₂ via nodes R₀ and R₁. At node R₂, the file setup message is looped back to S, preferably through a direct connection. This looping back alerts S that the pipeline is ready for the receipt of data, and is completely in the File Setup state. In a presently preferred embodiment only the terminal recipient node provides this loop back to the source node to indicate that the message has been successfully transmitted through the pipeline. A series of data blocks are then transmitted from S to R₀, where they are forwarded to R₁, which forwards them to R₂. This data block by data block transfer is performed for each data block in the file. As each node receives the data block it is written to the storage device, and with the exception of the terminal node, the nodes transfer the data block to the next node. Upon transmitting the last data block, data block N-1, source S can transmit a data complete message, which is propagated through the pipeline and looped back to source S. Upon determining that all nodes have completed the file transfer, by receipt of the looped back data complete message, source S re-enters the idle state.

When a node in the pipeline becomes unavailable it is dropped, and is termed a failed node. The node before the failed node sends data to the node after the failed node, and the pipeline continues to route the data accordingly. In a large file transfer, for instance in the transfer of animated character parameters to nodes in a distributed computer cluster used as a rendering farm, the pipeline makes use of the redundancy to avoid a situation where a failure of a node part way through a large data transfer forces the pipeline to fail, and requires the re-establishment of the pipeline to bypass the failed node. By utilizing the redundant connections to other nodes in the pipeline, the file transfer pipeline can self heal for any number of dropped nodes. For a large number of nodes, each having the same connection bandwidth, the data transfer rate is equivalent to the transfer rate of any one node. Thus the transfer time through a pipeline of an arbitrary length is equal to the time it would take the source to transfer the file to one node, plus some overhead associated with each node, and the overhead of establishing the connection. Though this is in theory more time than required to do a multicast, it greatly reduces the bandwidth used, as multicast transmissions across switches and hubs tend to be send as broadcasts to all nodes instead of multicasts to the selected nodes. Furthermore, the overhead and setup time are often negligible in comparison to the time taken to transfer a very large file set.

One skilled in the art will appreciate that the above teachings may be extendable to multiple concurrent pipelines, pipelines with a tree-type structure, a detached pipeline where the sender provides a URL to the first recipient node which then retrieves the file and pushes the data down the pipeline, pipelines that can dynamically add machines into the established pipeline, pipelines that can be re-ordered to accommodate optimized data transfer rates, and nodes that modify messages to provide information to subsequent nodes, and potentially the source nodes.

The above-described embodiments of the present invention are intended to be examples only. Alterations, modifications and variations may be effected to the particular embodiments by those of skill in the art without departing from the scope of the invention, which is defined solely by the claims appended hereto.

1. A method of one-to-many file transfer comprising:
establishing a pipeline from a source node to a terminal recipient node through a plurality of recipient nodes each having a connection to its nearest downstream neighbor and its next nearest downstream neighbor;
transferring a data block from the source node to an index recipient node in the plurality of recipient nodes;
at each of the plurality of recipient nodes, forwarding the received data block to the nearest downstream neighbor, and to a storage device; and
at the terminal node, forwarding the received data block to a storage device and sending the source node an acknowledgement.

2. The method of claim 1, wherein the terminal node receives the data block from a nearest upstream, neighbor in the plurality of recipient nodes.

3. The method of claim 1, wherein the step of establishing a pipeline includes transmitting a network setup message containing the pipeline layout to each of the plurality of recipient nodes and to the terminal recipient node.

4. The method of claim 3, wherein the nearest downstream neighbour and the next nearest downstream neighbour are determined in accordance with the pipeline layout.

5. The method of claim 3, wherein transmitting the network setup message to each recipient node includes:
transmitting the network setup message from the source node to the index recipient node;
at each of the plurality of recipient nodes, receiving the network setup message and forwarding it to the nearest downstream neighbor; and
at the terminal recipient node, receiving the network setup message and sending an acknowledgement to the source node.

6. The method of claim 1, wherein the step of transferring a data block is preceded by the step of transmitting a file setup message through the pipeline.

7. The method of claim 6, wherein the file setup message includes at least one attribute of a file to be transferred.

8. The method of claim 7, wherein the at least one attribute includes a file length and data block size.

9. The method of claim 1 further including the steps of
detecting, at one of the plurality of recipient nodes, a failure in its nearest downstream neighbor; and
routing around the failed node.

10. The method of claim 9, wherein the step of routing around the failed node includes transmitting data blocks to the next nearest neighbor to remove the failed node from the pipeline.

11. The method of claim 9, wherein the step of routing around the failed node includes designating the next nearest neighbor as the nearest neighbor in the pipeline.

12. A node for receiving a pipelined file transfer, the node being part of a pipeline, the node comprising:
an ingress edge for receiving a data block from an upstream node in the pipeline;
an egress edge for maintaining a data connection to a nearest downstream neighbour in the pipeline and for maintaining a redundant data connection to a next nearest downstream neighbour in the pipeline; and
a state machine for, upon receipt of the data block at the ingress edge, forwarding a messaging operator to the egress edge for transmission to the nearest downstream neighbour in the pipeline and for forwarding the received data block to a storage device.

13. The node of claim 12, including an ingress messaging interface for receiving messaging operators from upstream nodes.

14. The node of claim 13, wherein the ingress messaging interface includes means to receive a network setup operator containing a layout of the pipeline.

15. The node of claim 13, wherein the ingress messaging interface includes means to receive a file setup operator containing properties of the file being transferred.

16. The node of claim 12, wherein the messaging operator is the received data block.

17. The node of claim 12, wherein the node is the terminal node in the pipeline and the messaging operator is a data complete operator sent to the source of the pipelined file transfer.

18. The node of claim 12 further including a connection monitor for monitoring the connection with the nearest neighbour and next nearest neighbour through the egress port and for directing messages to be sent to next nearest neighbor in the pipeline when the nearest neighbor node has failed.

19. The node of claim 12 further including a messaging interface for receiving data nack operators from one of the nearest neighbour and the next nearest neighbour in the pipeline.

20. The node of claim 19, wherein the messaging interface includes means to retransmit a stored data block in response to a received data nack operator.

21. A method of establishing a one-to-many file transfer pipeline, the method comprising:
establishing a data connection from a source node to a recipient node and a terminal recipient node;
transferring to the recipient node, over the data connection, a network setup message; and
establishing a data connection from the recipient node to the terminal node and forwarding, from the recipient node, the received network setup message to the terminal recipient node.

22. The method of claim 21 further including the step of transmitting, from the terminal recipient node to the source node, a messaging operator indicating completion of the pipeline.

23. The method of claim 21 further including the step of the recipient node establishing a further one-to-many file transfer pipeline using the terminal recipient node as the recipient node.

24. A method of one-to-many file transfer comprising:
establishing a one-to-many file transfer pipeline between a source node, a recipient node and a terminal recipient node, the source node having data connections to both the recipient node and the terminal recipient node, and the recipient node having a data connection to the terminal recipient node;
transferring from the source node to the recipient node a data block;
forwarding, from the recipient node to the terminal node and to a storage device, the received data block; and
at the terminal recipient node, storing the received forwarded data block.
